(19) United States
(12) Patent Application Publication
(10) Pub. No.: US 2018/0137550 A1
(43) Pub. Date: May 17, 2018

(54) METHOD AND APPARATUS FOR PROVIDING PRODUCT INFORMATION

(71) Applicant: SAMSUNG ELECTRONICS CO., LTD., Suwon-si (KR)

(72) Inventors: Hyung-tak CHOI, Suwon-si (KR); Hae-hun YANG, Seoul (KR); He-jung YANG, Seongnam-si (KR); Dong-hyeon LEE, Suwon-si (KR); Hee-sik JEON, Yongin-si (KR); In-chul HWANG, Seoul (KR)

(21) Appl. No.: 15/812,450

(22) Filed: Nov. 14, 2017

(30) Foreign Application Priority Data
Nov. 15, 2016 (KR) 10-2016-0152236

(51) Int. Cl. G06Q 30/06; G06Q 30/02; G06F 17/30; H04L 12/58; G06N 3/08

(52) U.S. Cl. CPC G06Q 30/0623; G06Q 30/0256; G06F 17/30637; G06N 3/084; G06F 17/30867; H04L 51/046; G06F 17/30657

(57) ABSTRACT

An example method of providing information of a product includes receiving a user message for purchase of the product via a first chat window, creating a query indicating purchase conditions for purchase of the product by interpreting a meaning of the user message, providing the created query to at least one server, receiving information of the product registered with the at least one server from the at least one server, editing at least a portion of the information, based on the purchase conditions, and providing the edited information via the first chat window.

### CROSS-REFERENCE TO RELATED APPLICATION

This application is based on and claims priority under 35 U.S.C. Section 119 to Korean Patent Application No. 10-2016-0152236, filed on Nov. 15, 2016, in the Korean Intellectual Property Office, the disclosure of which is incorporated by reference herein in its entirety.

### BACKGROUND AND SUMMARY

### 1. Field

The present disclosure generally relates to methods and apparatuses for providing product information.

### 2. Description of Related Art

Recently, much attention has been paid to electronic devices using machine learning and artificial neural networks. As a large amount of data has been continuously accumulated, the performance of related hardware such as a central processing unit (CPU) has been improved, and self-learning algorithms such as deep learning have been developed.

An electronic device is capable of conducting rational decision-making in a similar way to a human being owing to machine learning for stochastically increasing a rate of recognition of bit data through self-learning and artificial neural network technology.

Deep learning may be also used to purchase a product from an external server by using a device. Thus, deep learning technology for efficiently providing a user with information regarding a product that the user wants to purchase is needed.

The present disclosure describes methods and apparatuses for providing product information.

Additional aspects will be set forth in part in the description which follows and, in part, will be apparent from the description.

According to an aspect of an example embodiment, a method of providing information of a product, performed by a device, includes receiving a user message for purchase of the product via a first chat window, creating a query indicating purchase conditions for purchase of the product by interpreting a meaning of the user message, providing the created query to at least one server, receiving information of the product registered with the at least one server from the at least one server, editing at least a portion of the information, based on the purchase conditions, and providing the edited information via the first chat window.

According to an aspect of another example embodiment, a device for providing information of a product includes an input interface configured to receive a user message for purchase of the product via a first chat window, a communicator configured to provide a created query to at least one server and receive information regarding the product registered with the at least one server from the at least one server; and a controller configured to create the query indicating purchase conditions by interpreting a meaning of the user message, edit at least a portion of the received information, based on the purchase conditions, and provide the editedinformation via the first chat window.

According to an aspect of another example embodiment, there is provided a non-transitory computer-readable recording medium having recorded thereon a program for executing the method in a computer.

### BRIEF DESCRIPTION OF THE DRAWINGS

These and/or other aspects, features and attendant advantages of the present disclosure will become apparent and more readily appreciated from the following detailed description, taken in conjunction with the accompanying drawings, in which like reference numerals refer to like elements, and wherein:

FIG. 1 is a diagram illustrating providing a user with product information via a chat window, performed by a device, according to an example embodiment;

FIG. 2 is a flowchart of a method of providing product information , performed by a device, according to an example embodiment;

FIG. 3 is a diagram illustrating providing product information based on user information and purchase history information, performed by a device, according to an example embodiment;

FIG. 4 is a diagram illustrating providing product information by reflecting therein a change in purchase conditions, performed by a device, according to an example embodiment;

FIG. 5 is a diagram illustrating periodically checking information of a server, performed by device, according to an example embodiment;

FIG. 6 is a diagram illustrating providing information regarding a change in the price of a product, performed by a device, according to an example embodiment;

FIG. 7 is a diagram illustrating exchanging messages with a server via a chat window, performed by a device, according to an example embodiment;

FIGS. 8 and 9 are block diagrams of devices according to example embodiments;

FIG. 10 is a functional block diagram of a processor according to an example embodiment;

FIG. 11 is a functional block diagram of a data learning interface according to an example embodiment;

FIG. 12 is a functional block diagram of a data recognition interface according to an example embodiment; and

FIG. 13 is a diagram functionally illustrating learning and recognition of data through connection between a device and a server, according to an example embodiment.

### DETAILED DESCRIPTION

Reference will now be made in detail to example embodiments, which are illustrated in the accompanying drawings, wherein like reference numerals refer to like elements throughout. In this regard, the present example embodiments may have different forms and should not be construed as being limited to the descriptions set forth herein. Accordingly, the example embodiments are merely described below, by referring to the figures, to explain certain aspects of the present disclosure. As used herein, the term ‘and/or’ includes any and all combinations of one or more of the associated listed items. Expressions such as ‘at least one of,’ when preceding a list of elements, modify the entire list of elements and do not modify the individual elements of the list.

Some example embodiments of the present disclosure may be represented using functional block components and various operations. Some or all of such functional blocks may be realized by any number of hardware and/or software components configured to perform specified functions. For example, functional blocks of the present disclosure may be embodied by one or more microprocessors or circuit constructions for predetermined functions. For example, functional blocks of the present disclosure may be implemented using various programming or scripting languages. The functional blocks may be embodied as an algorithm executable by one or more processors. Furthermore, the present disclosure may employ conventional techniques for electronics configuration, signal processing and/or data processing. The terms “mechanism”, “element”, “means”, “configuration”, etc. may be used broadly and are not limited to mechanical or physical example embodiments.

The lines or connecting elements shown in the appended drawings are intended to represent example functional relationships and/or physical or logical couplings between various elements. It should be noted that many alternative or additional functional relationships, physical connections or logical connections may be present in a practical device.

It will be understood that, although the terms “first”, “second”, etc., may be used herein to describe various elements, the elements should not be limited by these terms. These terms are only used to distinguish one element from another element.

Hereinafter, the present disclosure will be described in detail with reference to the accompanying drawings.

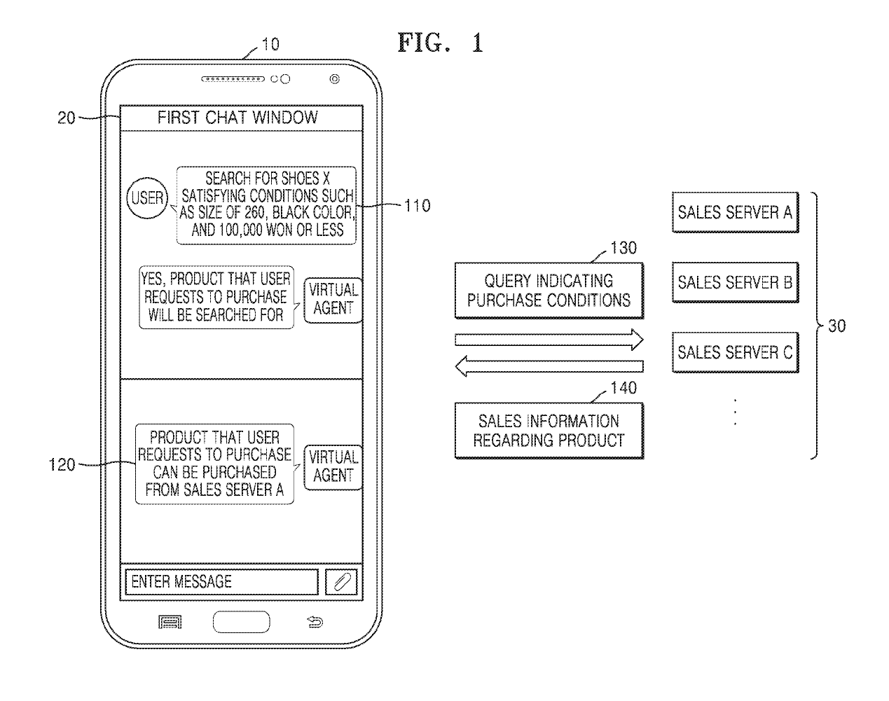

FIG. 1 is a diagram illustrating providing a user with product information (e.g., sales information) via a chat window, performed by a device, according to an example embodiment.

Referring to FIG. 1, a device 10 may request at least one server 30 (e.g., sales server A, sales server B, sales server C, etc.) to provide sales information by using a user's message 110 input by a user via a first chat window 20, and provide the sales information received from the at least one sales server 30 via the first chat window 20. In this case, the device 10 may learn a criterion for interpreting the meaning of the user's message 110 and the sales information received from the at least one sales server 30 to provide the user with sales information matching the user's purchase conditions.

The device 10 may provide the user with sales information of a product via the first chat window 20. The first chat window 20 may be a message window provided from a chatting application installed in the device 10. The device 10 may receive the user's message 110 for purchase of the product via the first chat window 20. Furthermore, the device 10 may provide a sales information message 120 regarding the product received from the at least one sales server 30 via the first chat window 20. Sales information 140 received from the at least one sales server 30 may be a text message, a voice message, and/or a video message but is not limited thereto. The user's message 110 and the sales information message 120 may be provided in a dialogue form on the first chat window 20, but is not limited thereto.

The device 10 may interpret the meaning of the user's message 110 and provide the at least one sales server 30 with a query 130 regarding purchase conditions for purchase of the product. The device 10 may receive the sales information 140 regarding the product registered with the at least one sales server 30 from the at least one sales server 30. The device 10 may provide the sales information message 120 by editing the sales information 140 received from the at least one sales server 30 based on the purchase conditions interpreted from the message 10.

Examples of the device 10 may include, but are not limited to, a smart phone, a tablet personal computer (PC), a PC, a smart television (TV), a cellular phone, a personal digital assistant (PDA), a laptop computer, a media player, a micro-server, a global positioning system (GPS) device, an e-book terminal, a digital broadcast terminal, a navigation device, a kiosk, an MP3 player, a digital camera, a wearable device, and other mobile or non-mobile computing devices. Examples of the device 10 may also include, without limitation, various types of devices capable of receiving a touch input, such as an electronic black board, a touch table, etc. Examples of the device 10 may also include, without limitation, a watch, glasses, a hairband, and a ring having a communication function and a data processing function.

The at least one sales server 30 may be, but is not limited to, a server of a business operator who manufactures and sells the product or a server of an agent who sells the product on behalf of the manufacturer of the product. Each of the at least one sales server 30 may include a sales agent, and the device 10 may exchange information with the sales agent of each of the at least one sales server 30. The sales agent may be a human being or artificial intelligence (AI) hardware and/or software, but is not limited thereto.

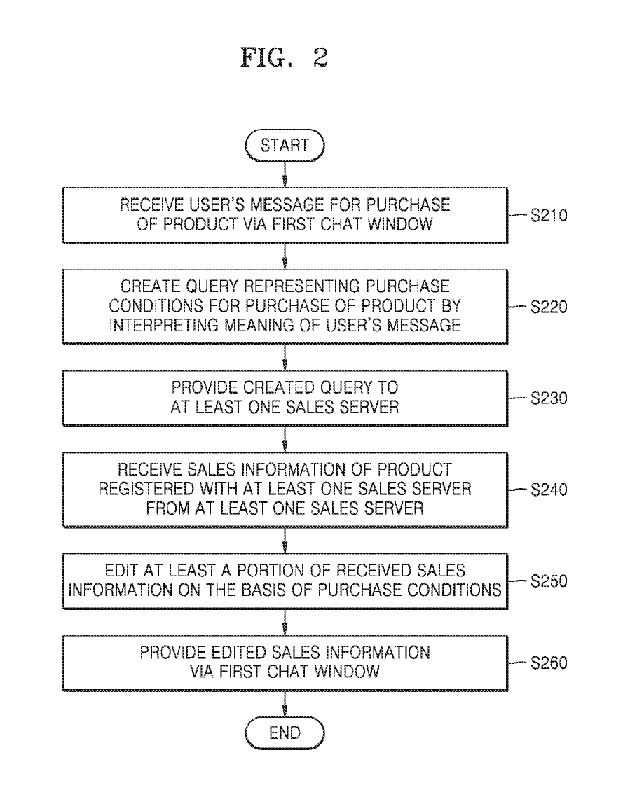

FIG. 2 is a flowchart of a method of providing product information, performed by a device, according to an example embodiment

Referring to FIG. 2, in operation S210, the device 10 may receive a user's message for purchase of a product via the first chat window 20. In one example embodiment, the device 10 may receive the user's message requesting to purchase the product. For example, the user's message for purchase of the product may include the name, size, and price information of the product that the user requests to purchase, but is not limited thereto. The message may be displayed in a dialogue form on the first chat window 20.

In operation S220, the device 10 may create a query representing purchase conditions for purchase of the product by interpreting the meaning of the user's message. The user's message may be a video message, a voice message, and/or a text message, but is not limited thereto.

In one example embodiment, the purchase conditions may be based on information which is related to the purchase of the product and which is included in the user's text message. For example, when the user's message includes text regarding the name, size, and price of the product, the device 10 may provide purchase conditions regarding the name, specific size, and price range of the product that the user wants to purchase based on the text. The device 10 may create a query indicating the purchase conditions.

The device 10 may create morpheme information by dividing the text of the user's message in units of morphemes. The device 10 may achieve the purchase conditions by analyzing the created morpheme information. For example, the device 10 may select actual morpheme information related to the purchase of the product from the created morpheme information. The device 10 may generate the purchase conditions by analyzing the selected actual morpheme information. The device 10 may create a query based on the generated purchase conditions. In one example embodiment, the query may be a natural-language sentence created from vowels of words which are included in the user's message and represent the purchase conditions and the words representing the purchase conditions, but the present disclosure is not limited thereto.

The device 10 may create the query based on the purchase conditions by using a virtual agent. The virtual agent may create the query by using a self-learning algorithm such as deep learning.

In one example embodiment, the virtual agent may include a data learning interface and a data recognition interface which will be described below, but the present disclosure is not limited thereto. The virtual agent may be manufactured in the form of a dedicated hardware chip for artificial intelligence (AI) or as a part of an existing general-purpose processor (e.g., a CPU or an application processor), and installed in the device 10. The virtual agent may be executed by an external server, and the device 10 may communicate with the external server to use the virtual agent located in the external server.

In operation S230, the device 10 may provide the created query to the at least one sales server 30. In one example embodiment, the device 10 may provide the created query to at least one sales agent of the at least one sales server 30. Alternatively, the query may be provided to only some of the at least one sales server 30 or some sales agent according to the purchase conditions. For example, when the purchase conditions related to the user's preference include information requesting to exclude a sales server 30 of a specific manufacturer, the device 10 may provide the created query to the remaining sales server 30 excluding the sales server 30 of the specific manufacturer.

In operation S240, the device 10 may receive sales information of the product registered with the at least one sales server 30 from the at least one sales server 30. In one example embodiment, the at least one sales server 30 may determine sales information to be transmitted to the device 10 among the sales information of the product registered with the at least one sales server 30 based on the query provided from the device 10. The device 10 may receive the sales information transmitted from the at least one sales server 30.

In one example embodiment, the device 10 may receive sales information which is highly related to the purchase conditions. The sales information which is highly related to the purchase conditions may be understood to mean sales information of the product which is sold according to conditions which are the same as the purchase conditions or for which a degree of similarity with the purchase conditions is greater than or equal to a predetermined level, but the present disclosure is not limited thereto. For example, when the name, specific size, and price range of the product that a user wants to purchase are determined as purchase conditions, the device 10 may receive sales information of the product matching the determined purchase conditions.

Alternatively, in one example embodiment, the device 10 may receive sales information of a product which is less related to the purchase conditions. The sales information of the product which is less related to the purchase conditions may be understood to mean sales information of the product which is sold according to conditions for which a degree of similarity with the purchase conditions is less than a predetermined level or sales information of the product of which some conditions are the same as the purchase conditions but is not limited thereto. For example, when the name, specific size, and price range of the product that a user wants to purchase are determined as purchase conditions, the device 10 may receive sales information of a product of which a size is not the same as the specific size but is similar to the specific size. Furthermore, the device 10 may receive sales information of a color of a product which is not included in a category of the purchase conditions.

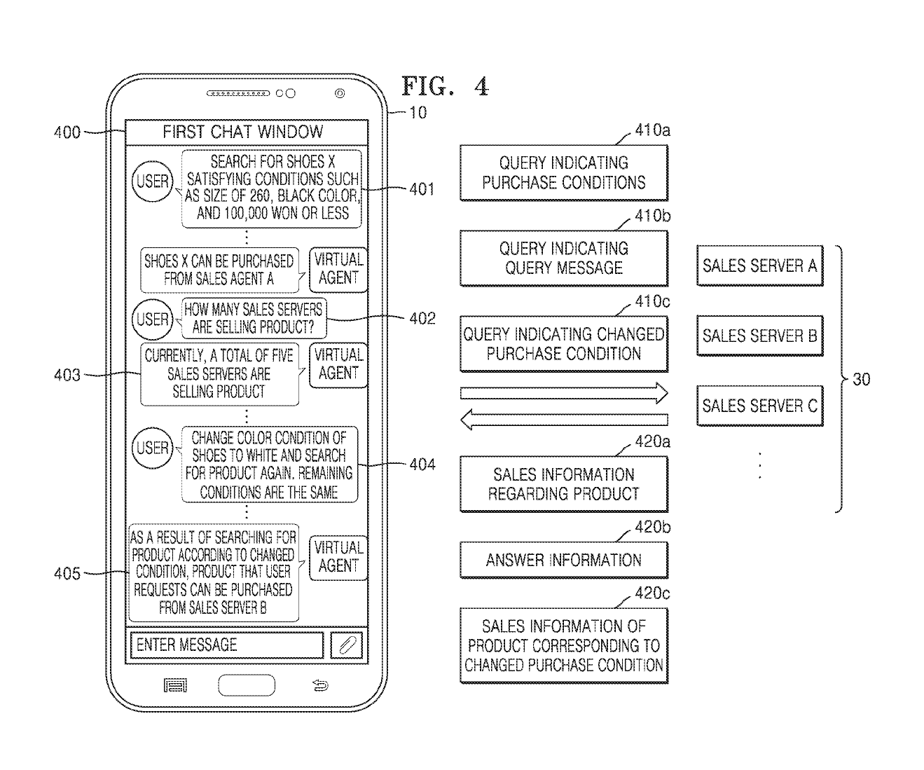

The sales information of the product which is less related to the purchase conditions may be used when the purchase conditions are changed by the user, as will be described in detail with reference to FIG. 4 below.

In operation S250, the device 10 may edit at least a portion of the received sales information based on the purchase conditions. The device 10 may receive not only sales information of a product which is highly related to the purchase conditions, but also sales information of a product which is less related to the purchase conditions. The device 10 may edit the sales information received from the at least one sales server 30 according to a degree of relation to the purchase conditions based on the purchase conditions so as to differentiate between the sales information of the product which is highly related to the purchase conditions and the sales information of the product which is less related to the purchase conditions. For example, when the received sales information matches 80% or more of a plurality of categories of the purchase conditions, the device 10 may determine the received sales information as sales information of a product which is highly related to the purchase conditions.

In one example embodiment, the device 10 may receive sales information in a data form from the at least one sales server 30 via a communication network. The device 10 may edit a part of the sales information received in the data form to display sales information of a product which is highly related to the purchase conditions in a sales-information message form on the first chat window 20. For example, when the device 10 receives sales information of a product which is highly related to the purchase conditions and sales information of a product which is less related to the purchase conditions from the at least one sales server 30, the device 10 may edit the sales information received from the at least one sales server 30 such that the sales information excluding the sales information of the product which is less related to the purchase conditions is provided via the first chat window 20.

The device 10 may edit at least a part of the received sales information by using a virtual agent, based on the purchase conditions.

In operation S260, the device 10 may provide the edited sales information via the first chat window 20. In one example embodiment, the device 10 may provide sales information of a product which is highly related to the purchase conditions via the first chat window 20 by editing the sales information received from the at least one sales server 30. For example, when the name, specific size, and price ranges of the product that the user wants to purchase are determined as purchase conditions, sales information corresponding to the categories of the purchase conditions may be provided while excluding sales information regarding a color of the product which is received from the at least one sales server 30. For example, the device 10 may create a sales information message by editing the sales information corresponding to the categories of the purchase conditions, and provide the sales information message via the first chat window 20. The device 10 may provide the sales information message in a dialogue form on the first chat window 20.

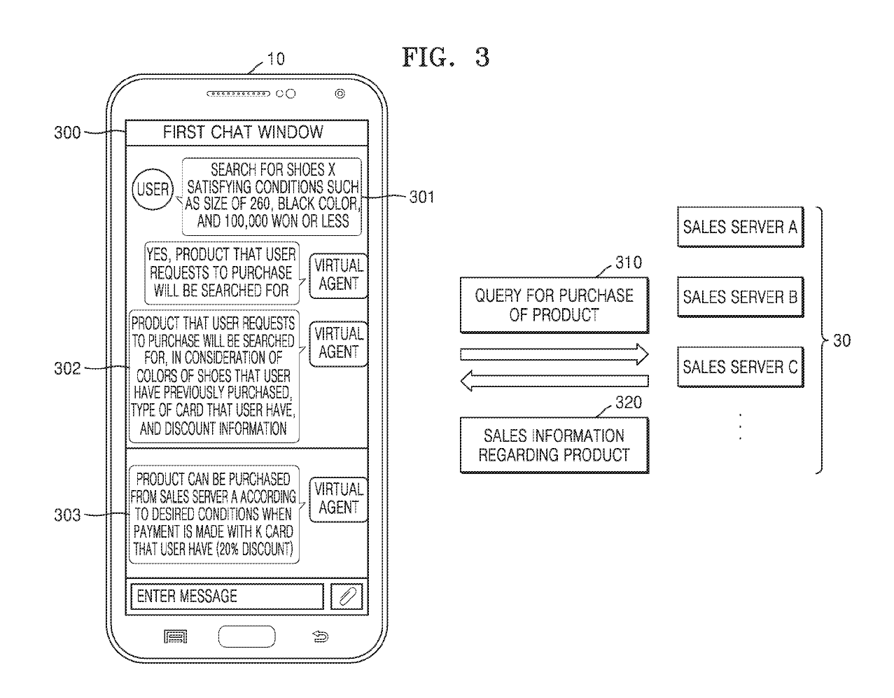

FIG. 3 is a diagram illustrating providing sales information of a product based on user information and purchase history information, performed by a device, according to an example embodiment.

Referring to FIG. 3, a device 10 may obtain user information and purchase history information regarding a user's purchase activities conducted using the device 10, which are stored therein. The device 10 may create a query 310 for purchase of a product based on the user information and the purchase history information by obtaining the user information and the purchase history information stored therein. Furthermore, the device 10 may receive a set value to be used for purchase of the product from the user, and create the query 310 for purchase of the product based on the set value. In one example embodiment, the device 10 may create the query 310 for purchase of the product by analyzing the user information, the purchase history information, and purchase-related information included in the set value received from the user.

For example, the user information may include, but is not limited to, information regarding a payment card that the user owns, discount information (mileages, points, etc.), information regarding products that the user owns, and preference information which is input by the user. The purchase history information may include the names, colors, sizes, design features, and price information of products which the user purchased, but the present disclosure is not limited thereto. The set value which may be received from the user is purchase-related information, e.g., a desired purchase date, which is not included in the user information and the purchase history information, but is not limited thereto.

For example, the device 10 may obtain purchase conditions, e.g., ‘shoes X, size of 260, and 100,000 won or less’, by interpreting the meaning of a message 301 received from the user via a first chat window 300. The device 10 may create the query 310 based on ‘card type and discount information’ as the user information stored in the device 10 and ‘color information of shoes that the user purchased’ as the purchase history information, as mentioned in a message 302, as well as the obtained purchase conditions. The device 10 may provide the query 310 for purchase of the product to the at least one sales server 30 and receive sales information 320 regarding the product from the at least one sales server 30.

The virtual agent of the device 10 described above may obtain the user information and the purchase history information stored in the device 10 and create the query 310 based on the user information and the purchase history information.

The device 10 may edit the received sales information 320 regarding the product to provide only sales information of the product satisfying the purchase conditions via the first chat window 300 among the sales information 320. For example, the device 10 may provide only information regarding a sales server (e.g., ‘a sales server A’) selling the product satisfying the purchase conditions and discount information (e.g., ‘20% discount for payment with a K card’) available to the user in the form of a message 303 via the first chat window 300.

FIG. 4 is a diagram illustrating providing sales information of a product by reflecting therein a change in purchase conditions, performed by a device, according to an example embodiment.

Referring to FIG. 4, a device 10 may receive a first query message 402 for purchase of a product from a user via a first chat window 400.

In one example embodiment, the device 10 may provide a first answer message 403 in reply to the first query message 402 via the first chat window 400 based on previously received sales information 420a regarding the product. For example, the device 10 may receive the first query message 402 saying ‘How many sales servers are selling the product?’ from the user via the first chat window 400, separately from the user's message 401 for purchase of the product. The device 10 may provide the first answer message 403 saying ‘The product is currently being sold at five sales servers.’ in reply to the first query message 402 via the first chat window 400 based on received sales information regarding the product.

In one example embodiment, the device 10 may newly create a query 410b indicating the received first query message 402, and provide it to at least one sales server 30. The device 10 may receive answer information 420b corresponding to the created query 410b, and provide the first answer message 403 in reply to the first query message 402 via the first chat window 400 based on the received answer information 420b. For example, when the previously received sales information 420a regarding the product does not include information which can be an answer to the first query message 402 inquiring into the number of sales servers selling the product, the device 10 may create the query 410b regarding the first query message 402, separately from a previously transmitted query 410a indicating purchase conditions, and provide the created query 410b to the at least one sales server 30. The device 10 may receive the answer information 420b (e.g., a ‘total five of sales servers’) with respect to the first query message 402 from the sales server 30. The device 10 may edit the received answer information 420b and provide the first answer message 403 via the first chat window 400.

The device 10 may receive the user's ‘change’ message 404 requesting to change the purchase conditions. The device 10 may change a query 410c indicating a changed purchase condition based on the user's ‘change’ message 404. The device 10 may provide the query 410c indicating the change purchase condition to the at least one sales server 30.

In one example embodiment, the device 10 may newly receive the user's ‘change’ message 404 requesting to change existing purchase conditions interpreted from the user's message 401 for purchase of the product. For example, when a purchase condition regarding a color which is interpreted from the user's message 401 is ‘black’, the device 10 may receive the user's ‘change’ message 404 requesting to change the purchase condition regarding a color to ‘white’. The device 10 may interpret the received ‘change’ message 404, newly create the query 410c indicating the changed purchase condition, and provide the created query 410c to the at least one sales server 30. The device 10 may receive sales information 420c of a product corresponding to the changed purchase condition from the at least one sales server 30, and provide sales information reflecting the changed purchase condition in the form of a sales information message 405 based on the received sales information 420c via the first chat window 400.

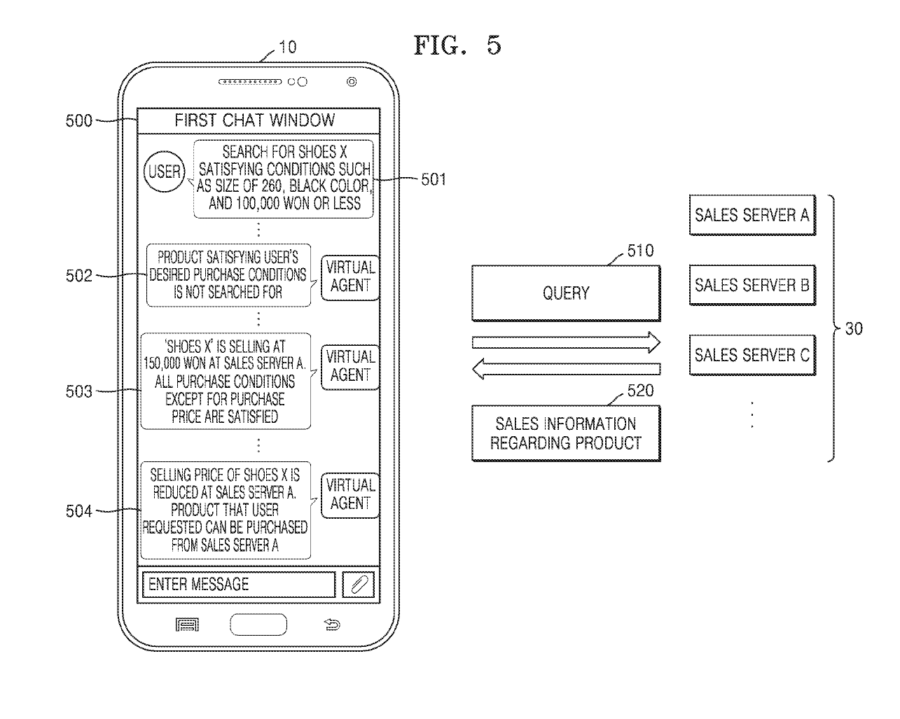

FIG. 5 is a diagram illustrating periodically checking sales information of a sales server, performed by device, according to an example embodiment.

Referring to FIG. 5, a device 10 may receive changed sales information 520 from at least one sales server 30 at predetermined time intervals. The predetermined time intervals may be intervals of one hour or intervals of one day, but the present disclosure is not limited thereto. The device 10 may receive a user input and change the predetermined time intervals. The device 10 may edit the changed sales information 520 and provide a result of editing the sales information 520 via a first chat window 500. The device 10 may request the at least one sales server 30 to provide the changed sales information 520 regarding a product at the predetermined time intervals, and receive the changed sales information 520 from the at least one sales server 30.

The sales information of the product registered with the at least one sales server 30 may be changed over time. The device 10 may request the at least one sales server 30 to provide the changed sales information 520 at the predetermined time intervals, and receive it from the at least one sales server 30.

In one example embodiment, the product satisfying purchase conditions may not be searched for from the at least one sales server 30 for a certain time period after the device 10 receives a user's message 501 for purchase of the product. The device 10 may provide a message 502 indicating that the product satisfying the purchase conditions is not searched for via the first chat window 500. Furthermore, the device 10 may receive the sales information 520 from the at least one sales server 30 at the predetermined time intervals. When receiving the changed sales information 520 regarding the product satisfying the purchase conditions, the device 10 may edit the changed sales information 520 and provide a result of editing the changed sales information 520 via the first chat window 500.

For example, when the sales information 520 received from the at least one sales server 30 does not include sales information of the product satisfying a purchase condition ‘100,000 won or less’ included in the user's message 501, the device 10 may provide the message 502 indicating that the product satisfying the purchase conditions is not searched for via the first chat window 500. Furthermore, the device 10 may receive the sales information 520 from the at least one sales server 30 at intervals of one day, and provide a message 503 indicating a result of editing the changed sales information 520 and a message 504 indicating a result of the changed sales information 520 regarding the product satisfying the purchase conditions via the first chat window 500.

The device 10 may receive the user's reserved message (not shown) when sales information of the product satisfying the purchase conditions is not received from the at least one sales server 30. In one example embodiment, the device 10 may receive a reserved message containing a purchase time limit and a purchase amount limit from the user. For example, the device 10 may receive a reserved message saying ‘Search for a product sold at 150,000 won or less unless a product satisfying 100,000 won or less as purchase price is searched for until 10^{th} of October’ from the user. The device 10 may create a query 510 reflecting ‘150,000 won’ which is a changed purchase price, and provide it to the at least one sales server 30 when a product satisfying ‘100,000 won’ as a purchase price until ‘10^{th} of October’ is not searched for.

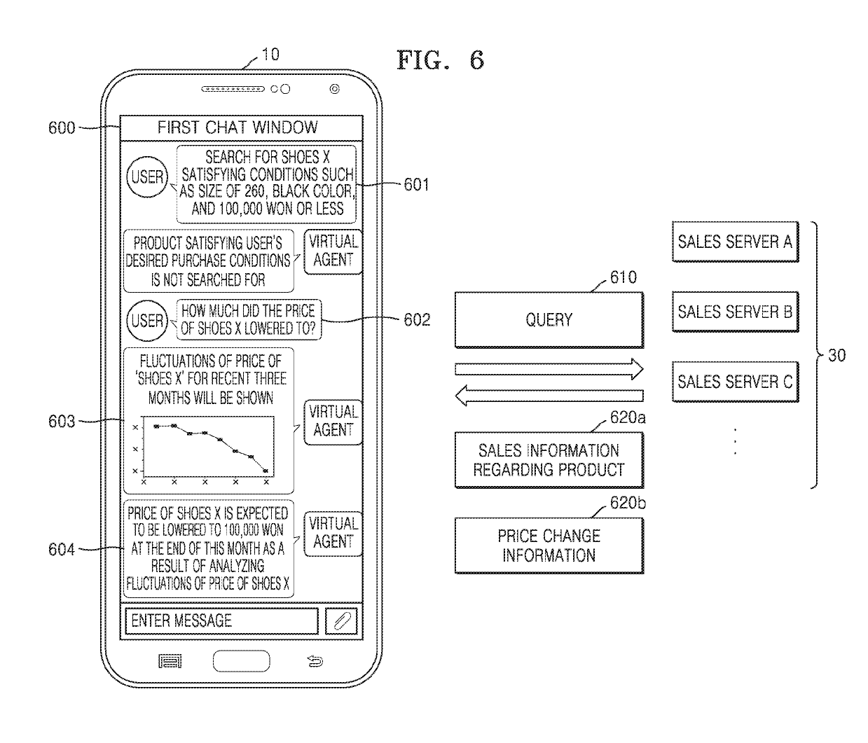

FIG. 6 is a diagram illustrating providing information regarding a change in the price of a product, performed by a device, according to an example embodiment.

Referring to FIG. 6, sales information provided by a device 10 via a first chat window 600 may include product price change information 603. The device 10 may provide price change information regarding a product indicated in a user's message 601 via the first chat window 600. The product price change information 603 may be provided in the form of a graph via the first chat window 600, but the present disclosure is not limited thereto.

In one example embodiment, the device 10 may receive not only sales information of a product which is highly related to purchase conditions included in the user's message 601, but also sales information of a product which is less related to the purchase conditions. For example, the device 10 may receive, as sales information 620a of a product, not only information regarding a current selling price of a product related to a purchase condition (‘100,000 won’) but also price change information of the product that user requests to purchase for a predetermined time period from the at least one sales server 30. When the received sales information 620a includes the price change information, the device 10 may not create any query and may edit the sales information 620a and provide a result of editing the sales information 620a as the product price change information 603 via the first chat window 600. For example, when receiving the user's price inquiry message 602 saying ‘How much does the price of shoes X decrease?’, the device 10 may provide, as the product price change information 603, a graph regarding ‘fluctuations in the price of the shoes X for recent three months’ included in the sales information 620a received as an answer via the first chat window 600.

In one example embodiment, after the user's price inquiry message 602 is received, the device 10 may receive the product price change information 603 to be used as an answer to the received user's price inquiry message 602 from the at least one sales server 30. When the received sales information 620a does not include price change information, the device 10 may create a query 610 requesting the at least one sales server 30 to provide price change information, and provide the query 610 to the at least one sales server 30. The device 10 may receive price change information 620b from the at least one sales server 30. The device 10 may edit the received price change information 620b, and provide a result of editing the received price change information 620b as the product price change information 603 through first chat window 600. For example, when receiving the user's price inquiry message 602 saying ‘How much does the price of the shoes X decrease?’, the device 10 may provide, as the product price change information 603, a graph regarding ‘fluctuations in the price of the Shoes x for recent three months’ included in the price change information 620b received as an answer via the first chat window 600.

The device 10 may predict prices of the product in the future based on price change information of the product received from the at least one sales server 30. A linear regression model based on the price change information may be used to predict the prices of the product in the future, but example embodiments are not limited thereto. The device 10 may calculate a point of time when the product will be sold according to a price condition included in the user's message 601 for purchase of the product by predicting the prices of the product in the future. The device 10 may provide information 604 regarding the point of time when the product will be sold at the price condition included in the user's message 601 via the first chat window 600. Furthermore, the device 10 may recommend a purchase time when a price of the product that the user requests to purchase will decrease. The device 10 may analyze a change in a price/total stock of a product family of the product that the user requests to purchase, and a change in the price of the product family of the product according to a change of season, and provide a message (not shown) recommending a purchase time via the first chat window 600.

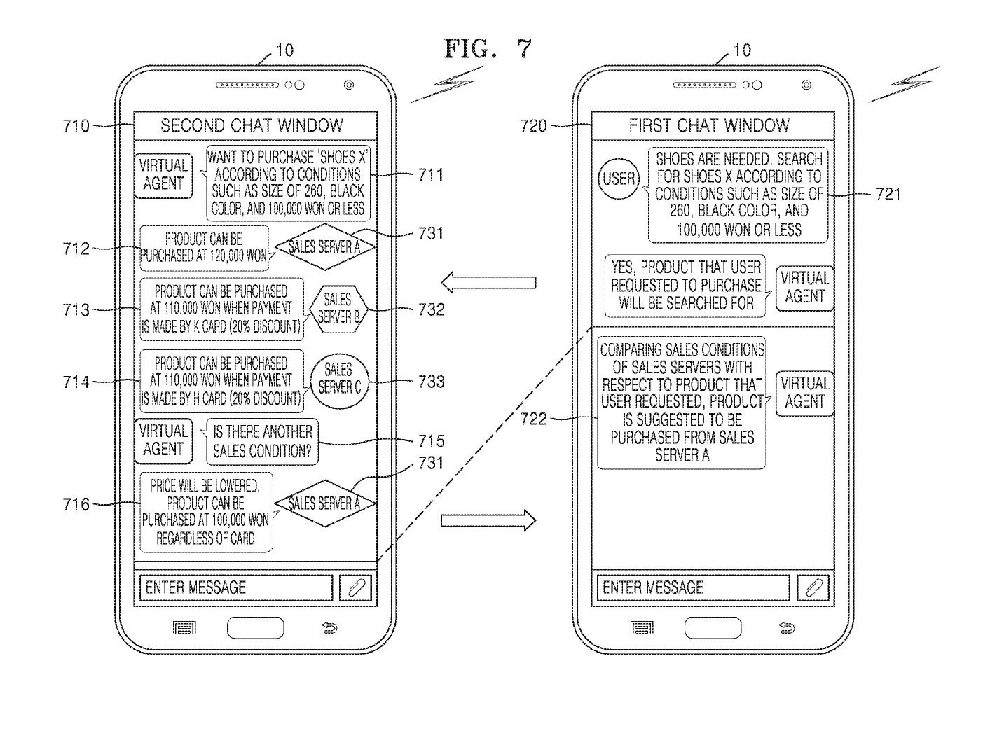

FIG. 7 is a diagram illustrating exchanging messages with a sales server via a chat window, performed by a device, according to an example embodiment. For convenience of explanation, a description of parts of FIG. 7 which are the same as those of FIG. 2 will be omitted below.

Referring to FIG. 7, a device 10 may create a second chat window 710 via which messages are to be transmitted to or received from at least one sales server. The second chat window 710 may be a message window provided by a chatting application installed in the device 10. Data transmitted or received during communication conducted between the device 10 and the at least one sales server may be displayed in a message form on the second chat window 710.

The device 10 may receive a user's message 721 for purchase of a product via a first chat window 720. The device 10 may obtain purchase conditions by interpreting the meaning of the user's message 721. The device 10 may provide a message 711 indicating the purchase conditions via the second chat window 710 by editing the user's message 721. The device 10 may provide the message 711 to at least one sales server via the second chat window 710.

The device 10 may provide sales information received from at least one sales server via the second chat window 710. The device 10 may edit the sales information received from the at least one sales server, and display sales information 712, 713 and 714 of sales servers 731, 732 and 733 which provide sales information that is highly related to the purchase conditions on the second chat window 710.

The device 10 may compare purchase conditions of the product obtained by interpreting the meaning of a user's message with sales information received from at least one sales server. In one example embodiment, the device 10 may compare a plurality of pieces of received sales information with each other on the basis of the purchase conditions and user information and purchase history information stored in the device 10.

In one example embodiment, sales information of the product sold by sales servers may be different. When sales information of a product matching the purchase conditions is not received, the device 10 may compare a plurality of pieces of sales information, which are not the same as the purchase conditions but are highly related to the purchase conditions, with each other. The device 10 may display the sales information 712, 713 and 714 of the sales servers 731, 732 and 733 which provide sales information being highly related to the purchase conditions on the second chat window 710.

The device 10 may determine one of the at least one sales server based on a result of comparing the plurality of pieces of sales information. The device 10 may determine a sales server selling a product which is most highly related to the purchase conditions by comparing a plurality of pieces of sales information of a product sold by sales servers with each other. For example, the device 10 may determine a sales server selling a product with a highest match rate with respect to a plurality of categories of the purchase conditions by calculating match rates of the plurality of pieces of sales information with respect to the plurality of categories of the purchase conditions.

Weights allocated to the plurality of categories of the purchase conditions may be different. In one example embodiment, the device 10 may set different weights to be allocated to the plurality of categories of the purchase conditions based on user information and a purchase history. Alternatively, the device 10 may receive a user input for setting weights and determine weights to be allocated to the plurality of categories of the purchase conditions.

The device 10 may edit sales information received form the determined sales server and provide a result of editing the sales information in a message form via the first chat window 720. In one example embodiment, the device 10 may provide sales information corresponding to the purchase conditions obtained from the user's message 721 among a plurality of pieces of sales information via the first chat window 720.

The device 10 may request at least one sales server to change sales conditions of the product to satisfy the purchase conditions. The sales conditions may be information included in sales information received from the at least one sales server. The device 10 may provide a message 715 requesting the at least one sales server to change the sales conditions of the product via the second chat window 710.

The device 10 may compare the purchase conditions with the changed sales conditions. The device 10 may provide a message 716 regarding the changed sales conditions received from the at least one sales server via the second chat window 710.

In one example embodiment, when the purchase conditions and the changed sales conditions are not the same, the device 10 may request the at least one sales server to change the sales conditions again. When the purchase conditions and the changed sales conditions are the same, the device 10 may edit sales information received from a sales server providing the changed sales conditions, and provide a result of editing the sales information in the form of a message 722 via the first chat window 720.

The device 10 may receive a user's comment message (not shown) regarding sales information via the first chat window 700. In one example embodiment, the device 10 may receive a user's comment message (not shown) indicating whether the user is satisfied with sales information provided to the user.

The device 10 may determine whether the user is satisfied with the sales information provided to the user by analyzing the received comment message. When the user's degree of satisfaction regarding the provided sales information is low, the device 10 may create a query by reflecting the user's feedback information included in the user's comment message. For example, the device 10 may create a query by reflecting feedback information saying ‘Search for a product preferred by persons in their twenties’, included in the comment message. The device 10 may provide the created query to at least one sales server.

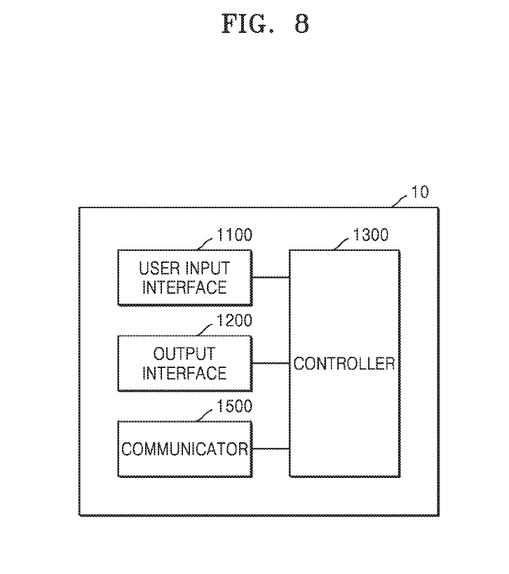

FIGS. 8 and 9 are block diagrams of devices according to example embodiments

As illustrated in FIG. 8, a device 10 according to an example embodiment may include a user input interface 1100, an output interface 1200, a controller 1300, and a communicator 1500. However, all the components illustrated in FIG. 8 are not indispensable components of the device 10. The device 10 may be embodied by other components, as well as the components illustrated in FIG. 8 or may be embodied by only some of the components illustrated in FIG. 8.

For example, as illustrated in FIG. 9, the device 10 according to an example embodiment may further include a sensor interface 1400, an audio/video (A/V) input interface 1600, and a memory 1700, as well as the user input interface 1100, the output interface 1200, the controller 1300, and the communicator 1500.

The user input interface 1100 should be understood to include, without limitation, input devices and associated components (e.g., circuitry) by which a user inputs data for controlling the device 10. Examples of the user input interface 1100 may include, without limitation, a key pad, a dome switch, a touch pad (a touch-type capacitive touch pad, a pressure-type resistive overlay touch pad, an infrared sensor-type touch pad, a surface acoustic wave conduction touch pad, an integration-type tension measurement touch pad, a piezo effect-type touch pad, etc.), a jog wheel, a jog switch, buttons, on-screen keyboard, and the like.

The user input interface 1100 may receive a user input via an auxiliary chat window. For example, the user input interface 1100 may receive a user input for inputting a message via the auxiliary chat window.

The output interface 1200 may include output devices and associated components (e.g., circuitry) for outputting an audio signal, a video signal, and/or a vibration (tactile, haptic) signal. The output interface 1200 may include a display 1210, a sound output interface 1220, and a vibration motor 1230.

The display 1210 (e.g., LCD display, OLED display, CRT display, and the like) displays information processed by the device 10. For example, the display 1210 may display a chat window and the auxiliary chat window. Furthermore, the display 1210 may display information regarding messages displayed on the chat window and the auxiliary chat window.

The sound output interface 1220 outputs audio data received by the communicator 1500 or stored in the memory 1700. Furthermore, the sound output interface 1220 outputs a sound signal related to a function performed by the device 10 (e.g., call signal reception sound, message reception sound, or notification sound). Examples of the sound output interface 1220 may include, without limitation, a speaker, a buzzer, and the like.

The vibration motor 1230 may output a vibration signal. For example, the vibration motor 1230 may output a vibration signal corresponding to output of audio data or video data (e.g., call signal reception sound, message reception sound, or the like). The vibrating motor 1230 may output a vibration signal when a touch is input to a touch screen.

Generally, the controller 1300 (e.g., a processor including processing circuitry, a CPU, and the like) controls overall operations of the device 10. For example, the controller 1300 may generally control the user input interface 1100, the output interface 1200, the sensors 1400, the communicator 1500, the AN input interface 1600, and other components by executing programs stored in the memory 1700.

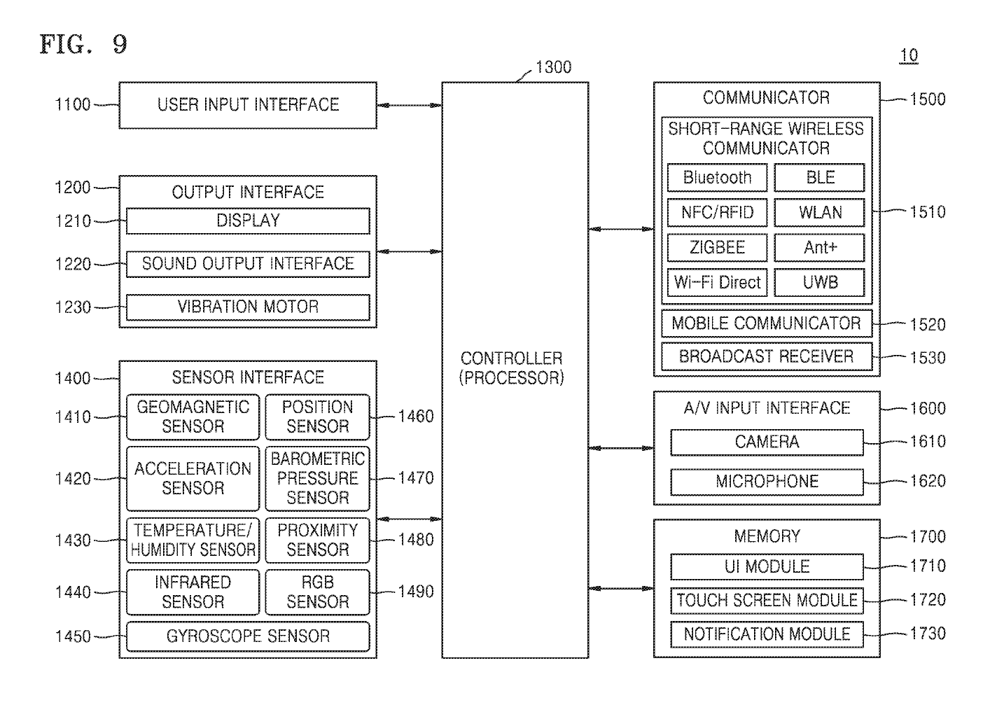

The controller 1300 may perform operations of the device 10 which have been described above with reference to FIGS. 1 to 7 and which will be described below with reference to FIGS. 10 to 13.

The controller 1300 may request the at least one sales server 30 to provide sales information by using a message input by the user via the first chat window, and provide sales information received from the at least one sales server 30 via the first chat window. In this case, the controller 1300 may learn a criterion for interpreting the meaning of the user's message and the sales information received from the at least one sales server 30 to provide the user with sales information matching the user's purchase conditions.

In detail, the controller 1300 may provide the user with product information (e.g., sales information) via the first chat window. The controller 1300 may create a query indicating the purchase conditions for purchase of the product by interpreting the meaning of the user's message. The controller 1300 may edit the sales information received from the at least one sales server 30 based on the purchase conditions interpreted from the user's message, and provide a sales information message. The controller 1300 may create a query based on the purchase conditions by using a virtual agent. In one example embodiment, the controller 1300 may provide the created query to at least one sales agent of the at least one sales server 30.

The controller 1300 may edit at least a part of the received sales information based on the purchase conditions. The controller 1300 may, for example, edit the sales information received from the at least one sales server 30 according to a degree of relation to the purchase conditions based on the purchase conditions so as to differentiate the sales information received by the communicator 1500 into sales information of a product which is highly related to the purchase conditions and sales information of a product which is less related to the purchase conditions. The controller 1300 may edit a part of sales information received in the form of data to provide sales information of the product which is highly related to the purchase conditions in the form of a sales information message via the first chat window.

The controller 1300 may provide the edited sales information via the first chat window. In one example embodiment, the controller 1300 may provide sales information of the product which is highly related to the purchase conditions via the first chat window by editing the sales information received from the at least one sales server 30. The controller 1300 may provide a sales information message in a dialogue form on the first chat window.

The controller 1300 may obtain user information and purchase history information regarding the user's purchase activities which are stored in the memory 1700. In one example embodiment, the user information and the purchase history information may be data received from an external server. The controller 1300 may obtain the user information and the purchase history information stored in the memory 1700, analyze the obtained user information and purchase history information, and create a query for purchase of the product based on the user information and the purchase history information. The controller 1300 may edit the received sales information of the product to provide only sales information of the product satisfying the purchase conditions among the received sales information via the first chat window.

The controller 1300 may provide a first answer message in reply to a first query message via the first chat window based on previously received sales information of the product. The controller 1300 may newly create a query representing the received first query message and provide the created query to the at least one sales server 30. The controller 1300 may receive answer information corresponding to the created query and provide the first answer message in reply to the first query message via the first chat window based on the received answer information.

The controller 1300 may change a query indicating changed purchases conditions based on the user's ‘change’ message requesting to change purchase conditions, received by the communicator 1500. The controller 1300 may provide the query indicating the changed purchase conditions to the at least one sales server 30.

The controller 1300 may provide the changed sales information via the first chat window based on changed sales information received from the at least one sales server 30 by the communicator 1500 at predetermined time intervals. The controller 1300 may edit the changed sales information and provide a result of editing the changed sales information via the first chat window. The controller 1300 may request the at least one sales server 30 to provide changed sales information of the product at the predetermined time intervals, and receive the changed sales information from the at least one sales server 30.

When sales information of a product satisfying the purchase conditions is not received from the at least one sales server 30, the controller 1300 may create a query reflecting the user's reserved message received by the communicator 1500 based on the reserved message. The controller 1300 may provide the created query to the at least one sales server 30 via the communicator 1500.

The controller 1300 may provide price change information regarding the product which is included in the user's message via the first chat window. When the price change information is not included in the received sales information, the controller 1300 may create an additional query requesting the at least one sales server 30 to provide price change information, and control the communicator 1500 to provide the created query to the at least one sales server 30. The controller 1300 may edit the price change information received from the at least one sales server 30, and provide the edited price change information via the first chat window.

The controller 1300 may predict a price of the product in the future by using price change information of the product received from the at least one sales server 30. The controller 1300 may provide information regarding a point of time when the product will be sold according to a price condition included in the user's message via the first chat window. Furthermore, the controller 1300 may recommend a point of time when a price of the product that the user requests to purchase will decrease.

The controller 1300 may create a second chat window via which a message may be transmitted to or received from at least one sales server. The controller 1300 may provide the sales information received from the at least one sales server via the second chat window.

The controller 1300 may interpret the meaning of the user's message and compare obtained purchase conditions of the product with the sales information received from the at least one sales server. In one example embodiment, the controller 1300 may compare a plurality of pieces of sales information with each other based on the purchase conditions and the user information and the purchase history information stored in the memory 1700. The controller 1300 may determine one of the at least one sales server 30 based on a result of comparing the plurality of pieces of sales information.

The controller 1300 may request the at least one sales server 30 to change sales conditions of the product to satisfy the purchase conditions. The controller 1300 may compare the purchase conditions with the changed sales conditions. The controller 1300 may provide a message regarding the changed sales conditions received from the at least one sales server 30 via the second chat window.

The controller 1300 may receive the user's comment message regarding the provided sales information via the first chat window. In one example embodiment, the controller 1300 may receive a comment message indicating whether the user is satisfied with the provided sales information or not.

The sensor interface 1400 may comprise one or more sensors for sensing a state of the device 10 or a state of the vicinity of the device 10, and transmitting information indicating a result of sensing the state of the device 10 or the state of the vicinity of the device 10 to the controller 1300.

Examples of sensors included in the sensor interface 1400 are, without limitation, one or more of a geomagnetic sensor 1410, an acceleration sensor 1420, a temperature/humidity sensor 1430, an infrared sensor 1440, a gyroscope sensor 1450, a position sensor (e.g., a global positioning system (GPS)) 1460, a barometric pressure sensor 1470, a proximity sensor 1480, and an RGB sensor (an illuminance sensor) 1490. Functions of these sensors are well-known and are therefore not described in detail here.

The communicator 1500 may include one or more components (e.g., communication circuitry) configured to establish communication between the device 10 and either another device (not shown) or the at least one sales server 30. For example, the communicator 1500 may include a short-range wireless communicator 1510, a mobile communicator 1520, and a broadcast receiver 1530.

Examples of the short-range wireless communicator 1510 may include, without limitation, one or more of a Bluetooth communicator, a Bluetooth low energy (BLE) communicator, a near-field communicator (NFC), a WLAN (Wi-Fi) communicator, a ZigBee communicator, an infrared data association (IrDA) communicator, a Wi-Fi Direct (WFD) communicator, a ultra-wideband (UWB) communicator, an Ant+communicator, and the like

The mobile communicator 1520 transmits a radio signal to or receives a radio signal from at least one among a base station, an external terminal, and a server in a mobile communication network. Examples of the radio signal may include, without limitation, a voice call signal, a video call signal, or various types of data generated during exchange of a text/multimedia message.

In detail, the communicator 1500 may receive the user's message for purchase of the product via the first chat window. In one example embodiment, the communicator 1500 may receive the user's message requesting to purchase the product.

The communicator 1500 may receive sales information regarding the product registered with the at least one sales server 30 from the at least one sales server 30. In one example embodiment, the communicator 1500 may receive sales information of a product which is highly related to the purchase conditions.

The communicator 1500 may receive the user's first query message for purchase of the product via the first chat window. The communicator 1500 may receive an answer message with respect to the first query message from the at least one sales server 30.

The communicator 1500 may receive the user's ‘change’ message requesting to change the purchase conditions. The communicator 1500 may receive sales information of the product corresponding to the changed purchase conditions from the at least one sales server 30.

The communicator 1500 may receive changed sales information from the at least one sales server 30 at predetermined time intervals.

The communicator 1500 may receive price change information regarding the product indicated in the user's message from the at least one sales server 30. The communicator 1500 may receive the user's price query message, and receive price change information to be used as an answer to the price query message, from the at least one sales server 30.

The broadcast receiver 1530 receives a broadcast signal and/or broadcast-related information from the outside via a broadcast channel. Examples of the broadcast channel may include, without limitation, a satellite channel and a terrestrial channel. In one example embodiment, broadcast receiver 1530 may be omitted from device 10.

The A/V input interface 1600 is configured to input an audio signal or a video signal, and may include, without limitation, a camera 1610, a microphone 1620, and the like. The camera 1610 may obtain a video frame, such as a still image or a moving picture, through an image sensor in a video call mode or a shooting mode. An image captured by the image sensor may be processed by the controller 1300 or an additional image processor (not shown).

A video frame processed by the camera 1610 may be stored in the memory 1700 or transmitted to the outside via the communicator 1500. Two or more cameras 1610 may be provided according to an example embodiment of a terminal.

The microphone 1620 receives an external audio signal and processes (transduces) it to an electrical audio data. For example, the microphone 1620 may receive an audio signal from an external device or a speaker. The microphone 1620 may use various noise rejection algorithms to remove noise generated during reception of an external audio signal.

The memory 1700 may store programs for performing operations of the controller 1300 or controlling the controller 1300, and store data input to or output from the device 10.

The memory 1700 may include one or more types of storage medium from among, without limitation, a flash memory type storage medium, a hard disk type storage medium, a multimedia card micro type storage medium, a card type memory (e.g., an SD or XD memory or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc.

The programs stored in the memory 1700 may be classified into a plurality of modules according to function. For example, the programs stored in the memory 1700 may be classified into a UI module 1710, a touch screen module 1720, a notification module 1730, etc.

The UI module 1710 may provide a specialized UI or GUI connected to the device 10 in interfaces of applications. The touch screen module 1720 may sense a user's touch gesture on a touch screen and transmit information regarding the touch gesture to the controller 1300. In one example embodiment, the touch screen module 1720 may recognize and analyze touch code. The touch screen module 1720 may be embodied as an additional hardware component having a controller.

Various sensors may be provided inside or near the touch screen to sense a touch or a proximity touch on the touch screen. A tactile sensor is an example of a touch sensor which senses a touch on the touch screen. The tactile sensor is a sensor capable of sensing a touch on a specific object to a degree to which a human being can feel or more. The tactile sensor is capable of sensing various types of information, such as the roughness of a contact surface, the hardness of a contact object, the temperature of a contact point, etc.

A proximity sensor is another example of a sensor which senses a touch on the touch screen.

The proximity sensor is a sensor capable of sensing the presence of an object approaching or located near a certain surface to be searched for by using force of an electromagnetic field or infrared light without a mechanical contact. Examples of the proximity sensor include, without limitation, a transmissive photoelectric sensor, a direct reflection type photoelectric sensor, a mirror reflection type photoelectric sensor, a high-frequency oscillation type proximity sensor, a capacitive proximity sensor, a magnetic proximity sensor, an infrared proximity sensor, and the like. Examples of a user's touch gesture include, without limitation, tapping, touching & holding, double tapping, dragging, panning, flicking, dragging & dropping, swiping, and the like.

The notification module 1730 may generate a signal indicating the occurrence of an event in the device 10. Examples of an event occurring in the device 10 include, without limitation, reception of a call signal, reception of a message, reception of a key signal, schedule notification, and the like. The notification module 1730 may output a notification signal in the form of a video signal via the display 1210, output a notification signal in the form of an audio signal via the sound output interface 1220, or output a notification signal in the form of a vibration signal via the vibration motor 1230.

FIG. 10 is a functional block diagram of a controller 1300 according to an example embodiment.

Referring to FIG. 10, the controller 1300 according to an example embodiment may include a data learning interface 1310 and a data recognition interface 1320.

The data learning interface 1310 may learn a criterion (or criteria) for creating a query for purchase of a product and a criterion (or criteria) for creating a sales information message. In one example embodiment, the data learning interface 1310 may learn a criterion (or criteria) for creating a query for purchase of the product by interpreting a message input by a user, and a criterion (or cirteria) for creating a sales information message to be provided to the user by editing sales information received from the at least one sales server 30. The data learning interface 1310 may learna criterion (or criteria) for creating a query, determining a type of data to be used to create a sales information message, determining as to how to create the query using the data, and determining as to how to create the sales information message. The data learning interface 1310 may learn a criterion (or criteria) for creating a query and creating a sales information message by obtaining data to be used for learning and applying the obtained data to a data recognition model which will be described below.

User information and purchase history information stored in the device 10, and an additional set value input by the user may be used to learn the criterion (or criteria) for creating a query and the criterion (or cirteria) for creating a sales information message. The data recognition interface 1320 may create a query by interpreting a message from a user, and create a sales information message to be provided to the user by editing sales information received from the at least one sales server 30. The data recognition interface 1320 may create a query by interpreting the user's message by using the learned data recognition model, and create a sales information message by editing certain sales information. The data recognition interface 1320 may create a query by obtaining data according to a predetermined criterion (or criteria) obtained through learning and interpreting the user's message by using the data recognition model with the obtained data as an input value, and create a sales information message by editing sales information. Furthermore, a result value output through the data recognition model using the obtained data as an input value may be used to update the data recognition model.

At least one of the data learning interface 1310 and the data recognition interface 1320 may be manufactured in the form of at least one hardware chip and installed in an electronic device. For example, at least one of the data learning interface 1310 and the data recognition interface 1320 may be manufactured in the form of a dedicated hardware chip for artificial intelligence (AI) or as a part of an existing general-purpose processor (e.g., a CPU or an application processor) or a dedicated graphic processor (e.g., a GPU), and installed in various types of electronic devices as described above.

In this case, the data learning interface 1310 and the data recognition interface 1320 may be installed in one electronic device or different electronic devices. For example, one of the data learning interface 1310 and the data recognition interface 1320 may be installed in an electronic device and the other may be installed in a server. Furthermore, the data learning interface 1310 and the data recognition interface 1320 may be connected to each other via wire or wirelessly to provide the data recognition interface 1320 with model information built by the data learning interface 1310 or provide the data learning interface 1310 with data input to the data recognition interface 1320 as data to be additionally learned.

At least one of the data learning interface 1310 and the data recognition interface 1320 may be embodied as a software module. When at least one of the data learning interface 1310 and the data recognition interface 1320 is embodied as a software module (or a program module including an instruction), the software module may be stored in a non-transitory computer-readable medium. In this case, at least one software module may be provided by an operating system (OS) or through a certain application. Alternatively, some of the at least one software module may be provided by the OS or the remaining software module may be provided through the certain application.

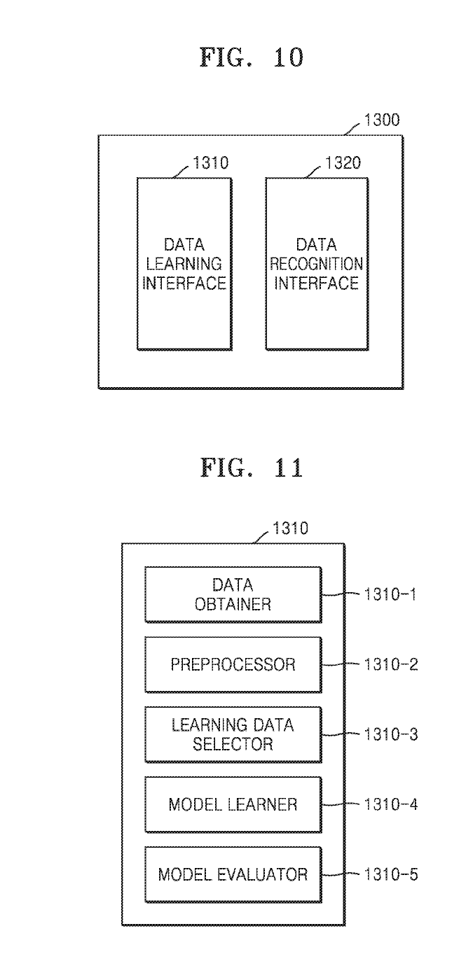

FIG. 11 is a functional block diagram of a data learning interface 1310 according to an example embodiment.

Referring to FIG. 11, the data learning interface 1310 according to an example embodiment may include a data obtainer 1310-1, a preprocessor 1310-2, a learning data selector 1310-3, a model learner 1310-4 and a model evaluator 1310-5.

The data obtainer 1310-1 may obtain data needed to create a query by interpreting a message input by a user and to create a sales information message to be provided to the user by editing sales information received from the at least one sales server 30. The data obtainer 1310-1 may obtain data needed to create a query and a sales information message. The data obtainer 1310-1 may receive text and access information stored in the device 10. For example, the data obtainer 1310-1 may obtain the received text and the stored information by sensing data from the device 10 including the data learning interface 1310. Alternatively, the data obtainer 1310-1 may receive data from an external server. For example, the data obtainer 1310-1 may obtain data from an external server of a business operator who manufactures and sells the product or an external server of an external server of a business operator who sells the product of a manufacturer on behalf of the manufacturer.

For example, the data obtainer 1310-1 may obtain voice data, video data, text data, bio-signal data, etc. For example, the data obtainer 1310-1 may receive text via a key pad, a dome switch, a touch pad, a jog wheel, or a jog switch of the device 10. Furthermore, the data obtainer 1310-1 may obtain data from an external device communicating with an electronic device.

The preprocessor 1310-2 may preprocess the obtained data so that this data may be used for learning to create a query and a sales information message. The preprocessor 1310-2 may process the obtained data into a predetermined format such that the model learner 1310-4 which will be described below may use the obtained data for learning to create a query and a sales information message. For example, the preprocessor 1310-2 may convert user information and purchase history information stored in the device 10 into text data. Furthermore, the preprocessor 1310-2 may convert voice data, video data or bio-signal data obtained by the data obtainer 1310-1 into text data.

The learning data selector 1310-3 may select data needed for learning from among the processed data. The selected data may be provided to the model learner 1310-4. The learning data selector 1310-3 may select data needed for learning from among the preprocessed data according to predetermined criterion (or criteria) for creating a query and sales information message. Alternatively, the learning data selector 1310-3 may select data according to a predetermined criterion (or criteria) obtained through learning performed by the model learner 1310-4 which will be described below.

The learning data selector 1310-3 may select data needed to purchase a product from among the preprocessed data.

A criterion (or criteria) for creating a query and sales information message based on learning data may be learned through the model learner 1310-4. Furthermore, a criterion (or criteria) regarding a type of learning data to be used to create a query and a sales information message may be learned through the model learner 1310-4.

The model learner 1310-4 may create a query indicating purchase conditions for purchase of the product by interpreting a message input by a user. Furthermore, the model learner 1310-4 may edit sales information received from the at least one sales server 30 based on the purchase conditions interpreted from the input message. The model learner 1310-4 may create a sales information message by editing the sales information.

In addition, a data recognition model to be used to create a query and a sales information message by using learning data may be learned through the model learner 1310-4. In this case, the data recognition model may be a prebuilt model. For example, the data recognition model may be a model which is prebuilt by receiving basic learning data (e.g., sample words, etc.).

The data recognition model may be built in consideration of the field of application of a recognition model, a purpose of learning, the computer performance of a device, or the like. The data recognition model may be, for example, a model based on a neural network. For example, a model such as a deep neural network (DNN), a recurrent neural network (RNN), or a bidirectional recurrent deep neural network (BRDNN) may be used as the data recognition model but exemplary embodiments are not limited thereto.

According to various example embodiments, when there are a plurality of prebuilt data recognition models, the model learner 1310-4 may determine a data recognition model of which basic learning data is highly related to input learning data as a data recognition model to be learned. In this case, the basic learning data may be previously classified according to data types and data recognition models may be prebuilt according to data types. For example, the basic learning data may be previously classified according to various criterion or criteria such as a region in which learning data was created, time when the learning data was created, the size of the learning data, the genre of the learning data, a creator of the learning data, the type of an object included in the learning data, and the like.

Furthermore, the data recognition model may be learned using, for example, a learning algorithm including error back-propagation or gradient descent through the model learner 1310-4.

Furthermore, the data recognition model may be learned, for example, using supervised learning which uses learning data as an input value through the model learner 1310-4. Alternatively, the data recognition model may be learned, for example, using unsupervised learning through the model learner 1310-4, in which the type of data needed to create a query and a sales information message may be self-learned without any supervision to detect criteria for creating a query and sales information message. In addition, the data recognition model may be learned, for example, using reinforcement learning through the model learner 1310-4, in which a query is created through learning and a sales information message is used as a feedback to determine whether a result of creating the query is appropriate.

When the data recognition model is learned, the model learner 1310-4 may store the learned data recognition model. In this case, the model learner 1310-4 may store the learned data recognition model in a memory of an electronic device including the data recognition interface 1320. Alternatively, the model learner 1310-4 may store the learned data recognition model in a memory of an electronic device including the data recognition interface 1320 which will be described below. Otherwise, the model learner 1310-4 may store the learned data recognition model in a memory of a server connected to an electronic device via wire or a wireless network.

In this case, the memory storing the learned data recognition model may store, for example, an instruction or data related to at least another component of an electronic device. Furthermore, the memory may store software and/or a program. The program may include, for example, a kernel, a middleware, an application programming interface (API) and/or an application program (or an ‘application’).

The model evaluator 1310-5 may input evaluation data to the data recognition model, and control the model learner 1310-4 to perform learning again when a recognition result output from the evaluation data does not satisfy a predetermined criterion (or criteria). In this case, the evaluation data may be predetermined data for evaluating the data recognition model.

Alternatively, the evaluation data may be achieved from a user's comment message. For example, the user may input a comment message indicating whether the output recognition result is satisfactory or not. The comment message may include the user's feedback information regarding the output recognition result.

For example, the model evaluator 1310-5 may evaluate that the predetermined criterion (or criteria) is not satisfied when the number or ratio of pieces of evaluation data corresponding to incorrect recognition results among recognition results of the learned data recognition model with respect to the evaluation data exceeds a predetermined threshold. For example, if a predetermined criterion is defined as a ratio of 2%, the model evaluator 1310-5 may evaluate that the learned data recognition model is not appropriate when incorrect recognition results are output from the learned data recognition model with respect to more than twenty pieces of evaluation data among a total of 1000 pieces of evaluation data.

When there are plurality of data recognition models, the model evaluator 1310-5 may evaluate whether they satisfy a predetermined condition and determine a data recognition model satisfying the predetermined condition as a final data recognition model. In this case, when a plurality of data recognition models satisfies the predetermined condition, the model evaluator 1310-5 may determine one data recognition model or a predetermined number of data recognition models which have been set beforehand according to their evaluation scores in an ascending order as final data recognition model(s).

At least one of the data obtainer 1310-1, the preprocessor 1310-2, the learning data selector 1310-3, the model learner 1310-4 and the model evaluator 1310-5 included in the data learning interface 1310 may be manufactured in the form of at least one hardware chip and installed in an electronic device. For example, at least one of the data obtainer 1310-1, the preprocessor 1310-2, the learning data selector 1310-3, the model learner 1310-4 and the model evaluator 1310-5 may be manufactured in the form of a dedicated hardware chip for artificial intelligence (AI) or as a part of an existing general-purpose processor (e.g., a CPU or an application processor) or a dedicated graphic processor (e.g., a GPU), and installed in various types of electronic devices.

The data obtainer 1310-1, the preprocessor 1310-2, the learning data selector 1310-3, the model learner 1310-4 and the model evaluator 1310-5 may be installed in one electronic device or different electronic devices. For example, some of the data obtainer 1310-1, the preprocessor 1310-2, the learning data selector 1310-3, the model learner 1310-4 and the model evaluator 1310-5 may be included in an electronic device and the remaining components may be included in a server.

At least one of the data obtainer 1310-1, the preprocessor 1310-2, the learning data selector 1310-3, the model learner 1310-4 and the model evaluator 1310-5 may be embodied as a software module. When at least one of the data obtainer 1310-1, the preprocessor 1310-2, the learning data selector 1310-3, the model learner 1310-4 and the model evaluator 1310-5 is embodied as a software module (or a program module including an instruction), the software module may be stored in a non-transitory computer-readable medium. In this case, the at least one software module may be provided by an OS or a predetermined application. Alternatively, some of the at least one software module may be provided by an OS and the remaining software module may be provided by an application.

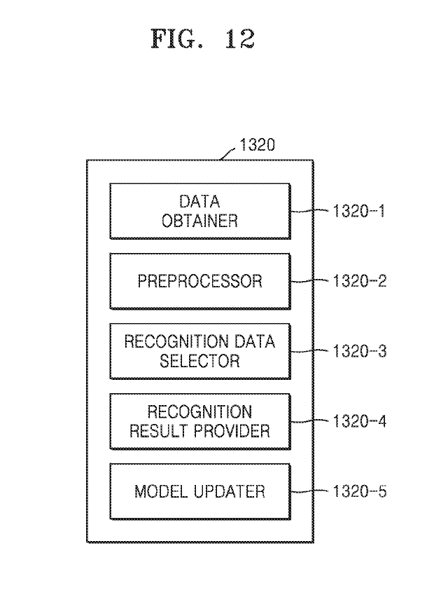

FIG. 12 is a functional block diagram of a data recognition interface 1320 according to an example embodiment.

Referring to FIG. 12, the data recognition interface 1320 according to an example embodiment may include a data obtainer 1320-1, a preprocessor 1320-2, a recognition data selector 1320-3, a recognition result provider 1320-4, and a model updater 1320-5.

The data obtainer 1320-1 may obtain data needed to create a query for purchase of a product and create a sales information message. The preprocessor 1320-2 may preprocess the obtained data so that this data may be used to create a query and a sales information message. The preprocessor 1320-2 may process the obtained data into a predetermined format so that the recognition result provider 1320-4 which will be described below may use the obtained data to create a query and a sales information message.

The recognition data selector 1320-3 may select data needed to create a query and a sales information message from among the preprocessed data. The selected data may be provided to the recognition result provider 1320-4. The recognition data selector 1320-3 may select some or the entire preprocessed data according to a predetermined criterion (or criteria) for creating a query and a sales information message. Alternatively, the recognition data selector 1320-3 may select data according to a predetermined criterion (or criteria) through learning conducted by the model learner 1310-4 which will be described below.

The recognition result provider 1320-4 may create a query and a sales information message by applying the selected data to a data recognition model. The recognition result provider 1320-4 may provide a recognition result according to a purpose of recognition of the data. The recognition result provider 1320-4 may apply the selected data to the data recognition model by using the data selected by the recognition data selector 1320-3 as an input value. The recognition result may be determined using the data recognition model.

In one example embodiment, a result of creating the query may be vowels of words which are included in a user's message and represent purchase conditions of purchase of the product or may be a natural-language sentence created from the words representing the purchase conditions. A result of creating the sales information message may be words or a sentence representing sales information of a product which is highly related to the purchase conditions. For example, the recognition result provider 1320-4 may provide the at least one sales server 30 with a natural-language sentence requesting product name, size information, color information, and price information. Alternatively, the recognition result provider 1320-4 may provide a natural-language sentence regarding product name, size information, and price information matching the purchase conditions.

The model updater 1320-5 may update the data recognition model based on an evaluation of the recognition result provided by the recognition result provider 1320-4. For example, the model updater 1320-5 may provide the recognition result provided by the recognition result provider 1320-4 to the recognition result so that the model learner 1310-4 may update the data recognition model.

At least one of the data obtainer 1320-1, the preprocessor 1320-2, the recognition data selector 1320-3, the recognition result provider 1320-4 and the model updater 1320-5 of the data recognition interface 1320 may be manufactured in the form of at least one hardware chip and installed in an electronic device. For example, at least one of the data obtainer 1320-1, the preprocessor 1320-2, the recognition data selector 1320-3, the recognition result provider 1320-4 and the model updater 1320-5 may be manufactured in the form of a dedicated hardware chip for artificial intelligence (AI) or as a part of an existing general-purpose processor (e.g., a CPU or an application processor) or a dedicated graphic processor (e.g., a GPU), and installed in various types of electronic devices as described above.

The data obtainer 1320-1, the preprocessor 1320-2, the recognition data selector 1320-3, the recognition result provider 1320-4 and the model updater 1320-5 may be installed in one electronic device or different electronic devices. For example, some of the data obtainer 1320-1, the preprocessor 1320-2, the recognition data selector 1320-3, the recognition result provider 1320-4 and the model updater 1320-5 may be included in one electronic device and the remaining components may be included in a server.

At least one of the data obtainer 1320-1, the preprocessor 1320-2, the recognition data selector 1320-3, the recognition result provider 1320-4 and the model updater 1320-5 may be embodied as a software module. When at least one of the data obtainer 1320-1, the preprocessor 1320-2, the recognition data selector 1320-3, the recognition result provider 1320-4 and the model updater 1320-5 is embodied as a software module (or at least one program module including an instruction), the software module may be stored in a non-transitory computer readable medium. In this case, at least one software module may be provided by an OS or an application. Alternatively, some of the at least one software module may be provided by the OS and the remaining software module may be provided by the application.

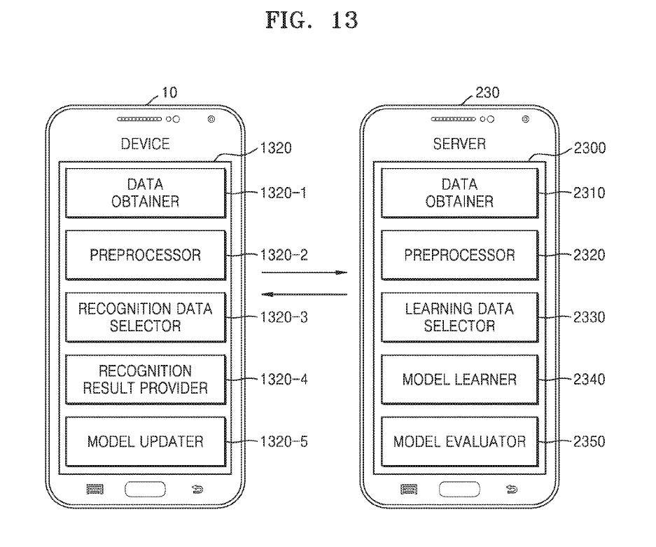

FIG. 13 is a diagram functionally illustrating learning and recognition of data through connection between a device 10 and a server 230, according to an example embodiment. The server 230 includes a module 2300 including a data obtainer 2310, a preprocessor 2320, a learning data selector 2330, a model learner 2340, and a model evaluator 2350.

Referring to FIG. 13, the server 230 may learn a criterion (or criteria) for creating a query for purchase of a product and a criterion (or criteria) for creating a sales information message, and the device 10 may create a query and a sales information message based on a result of learning conducted by the server 230.

In this case, a model learner 2340 of the server 230 may perform a function of the data learning interface 1310 of FIG. 11. The model learner 2340 of the server 230 may learn a criterion (or criteria) for creating a query, determining a type of data to be used to create a sales information message, determining as to how to create the query using the data, and determining as to how to create the sales information message. The model learner 2340 may learn a criterion (or criteria) for creating a query and creating a sales information message by obtaining data to be used for learning and applying the obtained data to a data recognition model which will be described below.

A recognition result provider 1320-4 of the device 10 may analyze sales information by applying data selected by a recognition data selector 1320-3 to a data recognition model created by the server 230. For example, the recognition result provider 1320-4 may transmit the data selected by the recognition data selector 1320-3 to the server 230 and request the server 230 to analyze the sales information by applying the data selected by the recognition data selector 1320-3 to a recognition model. Furthermore, the recognition result provider 1320-4 may receive a query and a sales information message created by the server 230 from the server 230.

For example, the device 10 may transmit text information of a message input by a user as data needed to create a query to the server 230. Furthermore, the device 10 may transmit sales information received from the at least one sales server 30 as data needed to create a sales information message to the server 230.

For example, the device 10 may receive the query and the sales information message created by the server 230.

Alternatively, the recognition result provider 1320-4 of the device 10 may receive a recognition model created by the server 230, and create a query and a sales information message by using the received recognition model. In this case, the recognition result provider 1320-4 of the device 10 may create a query and a sales information message by applying the data selected by the recognition data selector 1320-3 to the data recognition model received from the server 230. For example, the device 10 may create a query and a sales information message by applying text information of a message received from a user to the data recognition model received from the server 230.

One example embodiment may be embodied in the form of a computer-readable recording medium storing instructions which are executable by a computer, such as a computer-executable program module. The computer-readable recording medium may be any available medium accessible by a computer, and examples thereof include a volatile recording medium, a nonvolatile recording medium, a separable storing medium, and a non-separable recording medium. Examples of the computer-readable recording medium may further include a computer storage medium and a communication medium. Examples of the computer-readable recording medium may include a volatile recording medium, a nonvolatile recording medium, a separable recording medium and a non-separable recording medium manufactured according to any method or technology to store information such as computer-readable instructions, data structures, program modules, or other data. Generally, examples of the communication medium include a computer-readable instruction, a data structure, a program module, or other data of a modified data signal, other transmission mechanisms, or any information transfer medium.

In the present disclosure, the term “interface” may be understood to mean a hardware component such as a processor or a circuit and/or a software component executable by a hardware component such as a processor and/or a combination of a hardware component and a software component.

The example embodiments set forth herein are intended to provide examples and it will be apparent to those of ordinary skill in the art that various changes may be made in the example embodiments without departing from the technical idea of the present disclosure. Therefore, the example embodiments set forth herein should be considered in descriptive sense only and not for purposes of limitation. For example, components described herein as being combined with each other may be embodied separately from each other, and similarly, components described herein as being separated from each other may be embodied to be combined with each other.

Therefore, the scope of the present disclosure concept should be defined by the appended claims other than the detailed description, and all differences derived from the meaning and scope of the claims and concepts equivalent thereto thereof will be construed as falling within the scope of the present disclosure.

What is claimed is:

1. A method, performed by a device, of providing information of a product, the method comprising:
receiving a user message for purchase of the product via a first chat window;
creating a query indicating purchase conditions for purchase of the product by interpreting a meaning of the user's message;
providing the created query to at least one server;
receiving information of the product registered with the at least one server from the at least one server;
editing at least a portion of the information, based on the purchase conditions; and
providing the edited information via the first chat window.

2. The method of claim 1, further comprising obtaining user information stored in the device and purchase history information regarding user purchase activities conducted using the device, and
wherein the query is created based on the user information and the purchase history information.

3. The method of claim 1, wherein the received user message and the edited sales information are displayed in dialogue form in the first chat window.

4. The method of claim 1, further comprising:
receiving a first query message for purchase of the product; and
providing a first answer message in reply to the first query message, based on the received information.

5. The method of claim 1, wherein the providing of the created query to the at least one sales server comprises:
receiving a change message requesting to change the purchase conditions;
changing the created query, based on the change message; and
providing the changed query to the at least one server.

6. The method of claim 1, wherein the providing of the edited information comprises:
receiving changed information regarding the product from the at least one sales server at predetermined time intervals; and
editing and providing the changed information.

7. The method of claim 1, wherein the provided information comprises price change information of the product.

8. The method of claim 1, further comprising:
creating a second chat window to transmit a message to or receive a message from the at least one server;
providing a message indicating the purchase conditions to the at least one server via the second chat window; and
providing the received information via the second chat window.

9. The method of claim 1, wherein the providing of the edited information comprises:
comparing the purchase conditions of the product obtained from the user message with theinformation received from the at least one server;
determining one of the at least one server, based on a result of comparing the purchase conditions with theinformation; and
editing and providing the information received from the determined server.

10. The method of claim 9, wherein the comparing of the purchase conditions with the information comprises:
requesting the at least one server to change conditions of the product to satisfy the purchase conditions; and
comparing the purchase conditions with the changed conditions, and
wherein the changed conditions are included in the information.

11. A device for providing information of a product, the device comprising:
a communicator configured to receive a user message for purchase of the product via a first chat window, provide a created query to at least one server, and receive, from the at least one server, information regarding the product registered with the at least one server; and
a controller configured to create a query indicating purchase conditions by interpreting a meaning of the user message, edit at least a portion of the received information, based on the purchase conditions, and provide the edited information via the first chat window.

12. The device of claim 11, wherein the controller is configured to obtain user information stored in the device and purchase history information regarding user purchase activities conducted using the device, and to create the query based on the user information and the purchase history information.

13. The device of claim 11, wherein the communicator is configured to receive a first query message for purchase of the product, and
the controller is configured to provide a first answer message in reply to the first query message, based on the received information.

14. The device of claim 11, wherein the communicator is configured to receive a change message requesting to change the purchase conditions, and provide a changed query to the at least one server, and
the controller is configured to change the created query, based on the change message.

15. The device of claim 11, wherein the communicator is configured to receive changed information regarding the product from the at least one server at predetermined time intervals, and
the controller is configured to edit and provide the changed information.

16. The device of claim 11, wherein the provided information comprises price change information of the product.

17. The device of claim 11, wherein the controller is configured to create a second chat window to transmit a message to or receive a message from the at least one server, provide a message indicating the purchase conditions to the at least one server via the second chat window, and provide the received information via the second chat window.

18. The device of claim 11, wherein the controller is configured to compare the purchase conditions of the product obtained from the user message with the information received from the at least one server, determine one of the at least one server, based on a result of comparing the purchase conditions with the information, and edit and provide the information received from the determined server.

19. The device of claim 18, wherein the controller is configured to request the at least one server to change conditions of the product to satisfy the purchase conditions, and compare the purchase conditions with the changed conditions, and
wherein the changed conditions are included in the information.

20. A non-transitory computer-readable recording medium having recorded thereon a program that, when executed by a computer of a device for providing information about a product, causes the computer to control the device to:
receive a user message for purchase of the product via a first chat window;
create a query indicating purchase conditions for purchase of the product by interpreting a meaning of the user message;
provide the created query to at least one server;
receive information of the product registered with the at least one server from the at least one server;
edit at least a portion of the information, based on the purchase conditions; and
provide the edited information via the first chat window.
